(19) United States
(12) Patent Application Publication
(10) Pub. No.: US 2015/0020014 A1
(43) Pub. Date: Jan. 15, 2015

(54) INFORMATION PROCESSING APPARATUS, INFORMATION PROCESSING METHOD, AND PROGRAM

(71) Applicant: Sony Corporation, Tokyo (JP)

(72) Inventors: Seiji Suzuki, Kanagawa (JP); Shunichi Kasahara, Kanagawa (JP); Osamu Shigeta, Tokyo (JP); Ryo Fukazawa, Kanagawa (JP); Maki Mori, Tokyo (JP)

(73) Assignee: SONY CORPORATION, Tokyo (JP)

(21) Appl. No.: 14/379,059

(22) PCT Filed: Mar. 5, 2013
(86) PCT No.: PCT/JP2013/001342

§ 371 Date: Aug. 15, 2014

(30) Foreign Application Priority Data
Mar. 26, 2012 (JP) 2012-069714

(51) Int. Cl. G06F 3/0484; G06F 3/0481; G06F 3/0486; G06K 9/00; G06T 11/60

(52) U.S. Cl. CPC G06F 3/04842; G06K 9/00671; G06T 11/60; G06F 3/0486; G06F 3/0481; G06T 2200/24
USPC 715/769; 382/103; 715/846

(57) ABSTRACT

There is provided an information processing apparatus including an image acquiring unit configured to acquire at least one captured image; and an associating unit configured to associate a first information corresponding to a first object and a second information corresponding to a second object, wherein the acquired at least one captured image comprises at least one selectable object depicted therewithin, and at least one of the first object and the second object corresponds to a respective one or ones of the at least one selectable object.

### TECHNICAL FIELD

The present disclosure relates to an information processing apparatus, an information processing method, and a program.

### BACKGROUND ART

In recent years, due to the progress in image recognition technology, it has become possible to recognize various objects included in images produced by image pickup of a real space, for example, as well as the positions and postures of such objects. Such object recognition technologies are used for example in a technology called AR (Augmented Reality) which presents the user with additional information by overlaying information onto images of a real space. As one example of AR technology. JP 2003-256876A discloses a technique of displaying an image of a virtual object produced by modeling a real object, such as a piece of furniture, overlaid on an image of a real space so as to facilitate the user in trying different arrangements of furniture or the like.

### CITATION LIST

### Patent Literature

PTL 1: JP 2003-256876A

### SUMMARY

### Technical Problem

By using the AR technology described above, it is possible to display information relating to various objects included in an image produced by image pickup of a real space together with the image of the real space. Since the displaying of such information is a so-called “virtual display”, it is also possible for the user to operate the information in some way. However, technology relating to such operations is still immature.

For at least this reason, the present disclosure aims to provide a novel and improved information processing apparatus, information processing method, and program that enable objects recognized from an image to be operated more intuitively.

### Solution to Problem

According to an embodiment of the present disclosure, there is provided an information processing apparatus including an image acquiring unit configured to acquire at least one captured image, and an associating unit configured to associate a first information corresponding to a first object and a second information corresponding to a second object, wherein the acquired at least one captured image includes at least one selectable object depicted therewithin, and at least one of the first object and the second object corresponds to a respective one or ones of the at least one selectable object.

Further, according to an embodiment of the present disclosure, there is provided an information processing method including acquiring at least one captured image, identifying at least one of a first object and a second object as being found within the at least one captured image, and associating a first information corresponding to the first object and a second information corresponding to the second object.

Further, according to an embodiment of the present disclosure, there is provided a non-transitory computer-readable medium embodied with a program, which when executed by a computer, causes the computer to perform a method including acquiring at least one captured image, identifying at least one of a first object and a second object as being found within the at least one captured image, and associating a first information corresponding to the first object and a second information corresponding to the second object.

Further, according to an embodiment of the present disclosure, there is provided an information processing apparatus including an operation information acquiring unit acquiring operation information showing an operation by a user who indicates a first object and a second object from objects that are recognized from a picked-up image, and an associating unit associating first information corresponding to the first object and second information corresponding to the second object based on the operation information.

Further, according to an embodiment of the present disclosure, there is provided an information processing method including acquiring operation information showing an operation by a user who indicates a first object and a second object from objects that are recognized from a picked-up image, and associating first information corresponding to the first object and second information corresponding to the second object based on the operation information.

Further, according to an embodiment of the present disclosure, there is provided a program for causing a computer to realize a function acquiring operation information showing an operation by a user who indicates a first object and a second object from objects that are recognized from a picked-up image, and a function associating first information corresponding to the first object and second information corresponding to the second object based on the operation information.

According to embodiments of the present disclosure, by selecting objects (that is, virtual information) recognized from an image, it is possible to carry out operations that associate information (that is, information on real entities) corresponding to such objects. Such operations can be more intuitive to the user.

### Advantageous Effects of Invention

According to the present disclosure as described above, it is possible to operate objects recognized from an image more intuitively.

### BRIEF DESCRIPTION OF DRAWINGS

FIG. 1 is a diagram illustrating an overview of a first embodiment of the present disclosure.

FIG. 2 is a diagram illustrating an example of a picked-up image for the example in FIG. 1.

FIG. 3 is a schematic block diagram illustrating the functional configuration of a system according to the first embodiment of the present disclosure.

FIG. 4 is a diagram illustrating an example of a display screen according to the first embodiment of the present disclosure.

FIG. 5 is a diagram illustrating an example of object data according to the first embodiment of the present disclosure.

FIG. 6 is a flowchart illustrating an example of processing according to the first embodiment of the present disclosure.

FIG. 7 is a diagram illustrating a first example of the displaying of candidate objects according to the first embodiment of the present disclosure.

FIG. 8 is a diagram illustrating a second example of the displaying of candidate objects according to the first embodiment of the present disclosure.

FIG. 9 is a diagram illustrating an overview of a second embodiment of the present disclosure.

FIG. 10 is a diagram illustrating an example of a picked-up image for the example in FIG. 9.

FIG. 11 is a schematic block diagram illustrating the functional configuration of a system according to the second embodiment of the present disclosure.

FIG. 12 is a block diagram illustrating the hardware configuration of an information processing apparatus.

### DESCRIPTION OF EMBODIMENTS

Hereinafter, embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The following description is given in the order indicated below.

### 1. First Embodiment

### 1-1. Overview

### 1-2. Apparatus Configurations

### 1-3. Example of Processing

### 1-4. Example Display of Candidate Objects

### 2. Second Embodiment

### 2-1. Overview

### 2-2. Apparatus Configurations

### 3. Other Embodiments

### 4. Supplement

### 1. First Embodiment

### 1-1. Overview

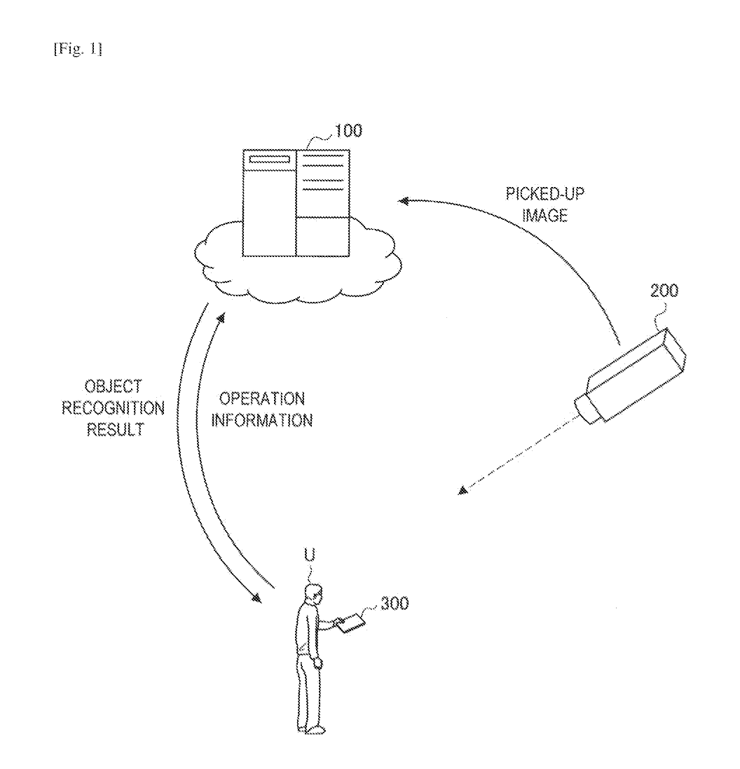

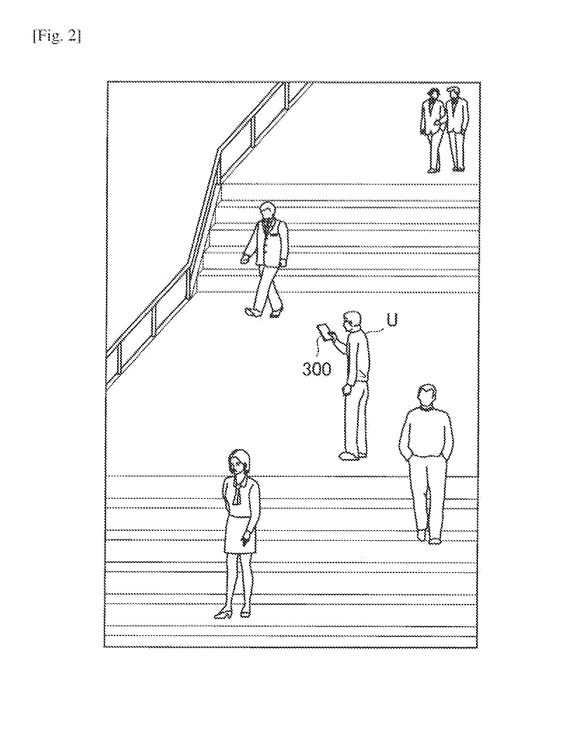

First, an overview of a first embodiment of the present disclosure will be described with reference to FIGS. 1 and 2. FIG. 1 is a diagram illustrating an overview of the first embodiment. FIG. 2 is a diagram illustrating an example of a picked-up image for the example in FIG. 1.

As illustrated in FIG. 1, the first embodiment relates to a server apparatus 100 (one example of an “information processing apparatus”), an overhead camera 200, and a terminal apparatus 300. The server apparatus 100 may acquire a picked-up image from the overhead camera 200 and supply an object recognition result for the picked-up image to the terminal apparatus 300. The terminal apparatus 300 may acquire operation information for an operation by a user U of the picked-up image including the object recognition result, and provide the operation information to the server apparatus 100. As illustrated in FIG. 2, the image picked-up by the overhead camera 200 may be an image picked up from a viewpoint that covers a region including the user U holding the terminal apparatus 300, for example.

### 1-2. Apparatus Configurations

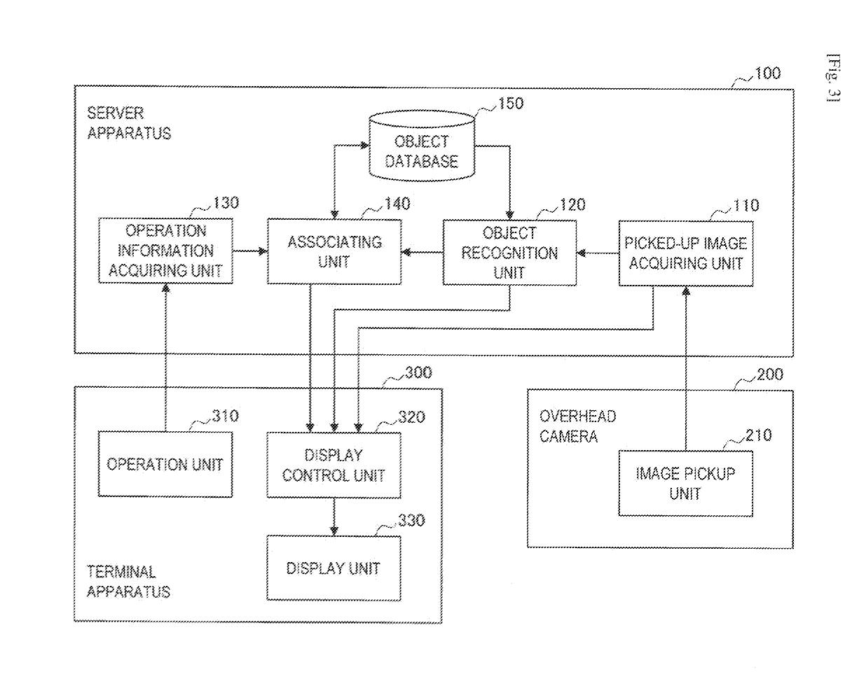

Next, the apparatus configurations in accordance with the first embodiment of the present disclosure will be described with reference to FIG. 3. FIG. 3 is a schematic block diagram illustrating the functional configuration of a system according to the first embodiment.

(Configuration of Server Apparatus)

As illustrated in FIG. 3, the server apparatus 100 may include a picked-up image acquiring unit 110, an object recognition unit 120, an operation information acquiring unit 130, an associating unit 140, and an object database 150. The picked-up image acquiring unit 110, the object recognition unit 120, the operation information acquiring unit 130, and the associating unit 140 may be realized for example by a CPU (Central Processing Unit), a RAM (Random Access Memory), and a ROM (Read Only Memory) of the server apparatus 100 operating according to a program stored in a storage unit. As examples, the object database 150 may be realized by various types of storage apparatus provided inside or outside the server apparatus 100.

Note that such server apparatus 100 does not need to be realized by a single apparatus. For example, by operating cooperatively via a network, the resources of a plurality of apparatuses may realize the functions of the server apparatus.

The picked-up image acquiring unit 110 may acquire image data of the picked-up image acquired by the overhead camera 200. The picked-up image acquiring unit 110 may provide the acquired image data to the object recognition unit 120. The picked-up image acquiring unit 110 may transmit the acquired image data to the terminal apparatus 300 to have the image data displayed as an image of a real space.

The object recognition unit 120 may recognize objects included in the picked-up image using the image data provided from the picked-up image acquiring unit 110. As one example, the object recognition unit 120 may match a set of feature points extracted from a picked-up image against the form of objects defined by model data. The object recognition unit 120 may match image data such as a symbol mark or a text label defined by the model data against a picked-up image. Also, the object recognition unit 120 may match feature amounts of images of existing objects defined by the model data against feature amounts extracted from a picked-up image.

Note that as examples, the model data may include data defining the forms of various objects, image data such as specified symbol marks or text labels attached to each object, and data of a feature amount set extracted from an existing image for each object. As one example, the model data may be acquired by referring to the object database 150.

The object recognition unit 120 may transmit information on the result of object recognition to the terminal apparatus 300. As one example, the information on the result of object recognition may be information for identifying the recognized objects and information on the positions and postures (inclination, rotation, and the like) of such objects in the picked-up image. In addition, the information on the result of object recognition may include information on graphics to be displayed corresponding to the recognized objects.

The operation information acquiring unit 130 may acquire information on an operation by the user U acquired by the terminal apparatus 300. As will be described later, the operation by the user U acquired here may be an operation that indicates a first and a second object recognized by the object recognition unit 120. The operation information acquiring unit 130 may provide information on the acquired operation by the user U to the associating unit 140.

The associating unit 140 may associate information corresponding to the first and second objects recognized by the object recognition unit 120 based on the information relating to the operation by the user U provided from the operation information acquiring unit 130. More specifically, if it is possible to associate the information respectively corresponding to the first and second objects recognized by the object recognition unit 120 with each other, the associating unit 140 may associate such information when an operation by the user U indicating such objects is acquired.

The associating unit 140 may acquire the information corresponding to each object by referring to the object database 150, for example. The associating unit 140 may also update the content of the object database 150 as a result of the information corresponding to respective objects being associated. Also, the associating unit 140 may transmit information showing the result of the associating process or information that supplements the operation by the user U relating to this associating to the terminal apparatus 300.

(Configuration of Overhead Camera)

As illustrated in FIG. 3, the overhead camera 200 may include an image pickup unit 210. Note that as another component, the overhead camera 200 may also include a communication circuit for communicating with the server apparatus 100 or the like, as may be appropriate.

As one example, the image pickup unit 210 may be realized by an image pickup device incorporated in the overhead camera 200 and may generate picked-up images for a real space. The image pickup unit 210 may pick up video images or may pick up still images. The image pickup unit 210 may transmit image data on the generated picked-up images to the server apparatus 100.

(Configuration of Terminal Apparatus)

As illustrated in FIG. 3, the terminal apparatus 300 may include an operation unit 310, a display control unit 320, and a display unit 330. Note that the terminal apparatus 300 may also include a communication circuit for communicating with the server apparatus 100 or the like, as may be appropriate.

The operation unit 310 may acquire an operation of the terminal apparatus 300 by the user U and may be realized by various types of input devices, such as a touch panel or a button or buttons, provided in the terminal apparatus 300 or connected to the terminal apparatus 300 as an externally connected appliance. As one example, the operation unit 310 may acquire an operation by the user U in a display screen displayed on the display unit 330 to indicate a first and a second object displayed as a result of object recognition. The operation unit 310 may transmit information on the acquired operation by the user U to the server apparatus 100. Note that in embodiments, it may be assumed that the operation unit 310 includes at least a touch panel.

As one example, the display control unit 320 may be realized by the CPU, RAM, and ROM of the terminal apparatus 300 operating according to a program stored in a storage unit and may control displaying by the display unit 330. The display control unit 320 may receive information for displaying an image on the display unit 330 from the server apparatus 100. As one example, the display control unit 320 may receive image data of a picked-up image that has been acquired by the overhead camera 200 and transmitted by the picked-up image acquiring unit 110. Also, the display control unit 320 may receive information on the result of object recognition for picked-up images transmitted by the object recognition unit 120. In addition, the display control unit 320 may receive information that supplements the operation by the user U relating to the associating that has been transmitted by the associating unit 140.

The display unit 330 may be realized by a display such as an LCD (Liquid Crystal Display), an organic EL (Electro-Luminescence) display, or the like that the terminal apparatus 300 may include as an output apparatus or that may be connected to the terminal apparatus 300 as an externally connected appliance, for example. The display unit 330 may display various images in accordance with control by the display control unit 320. Note that examples of images to be displayed on the display unit 330 will be described later.

### 1-3. Example of Processing

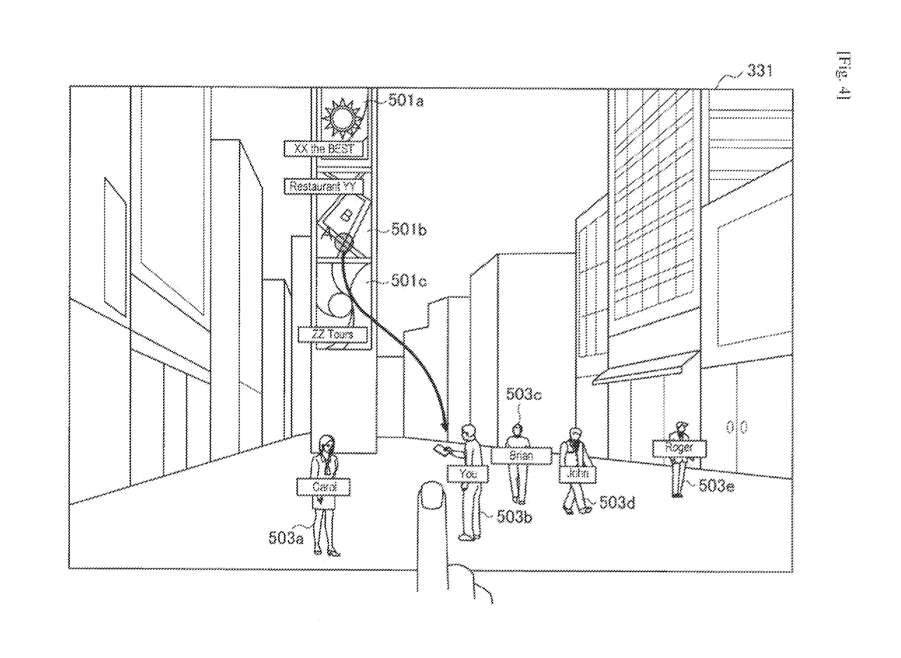

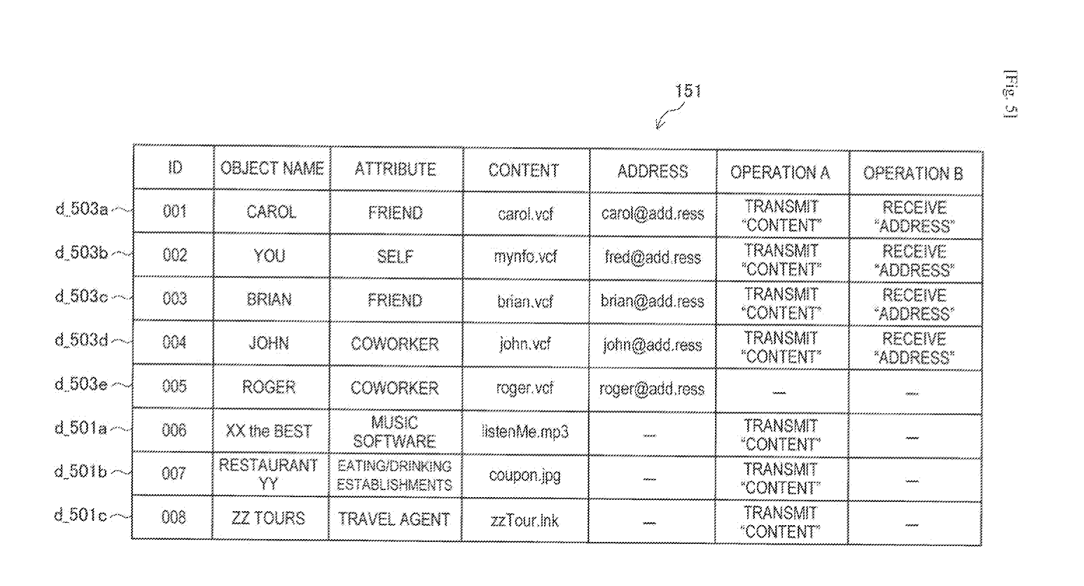

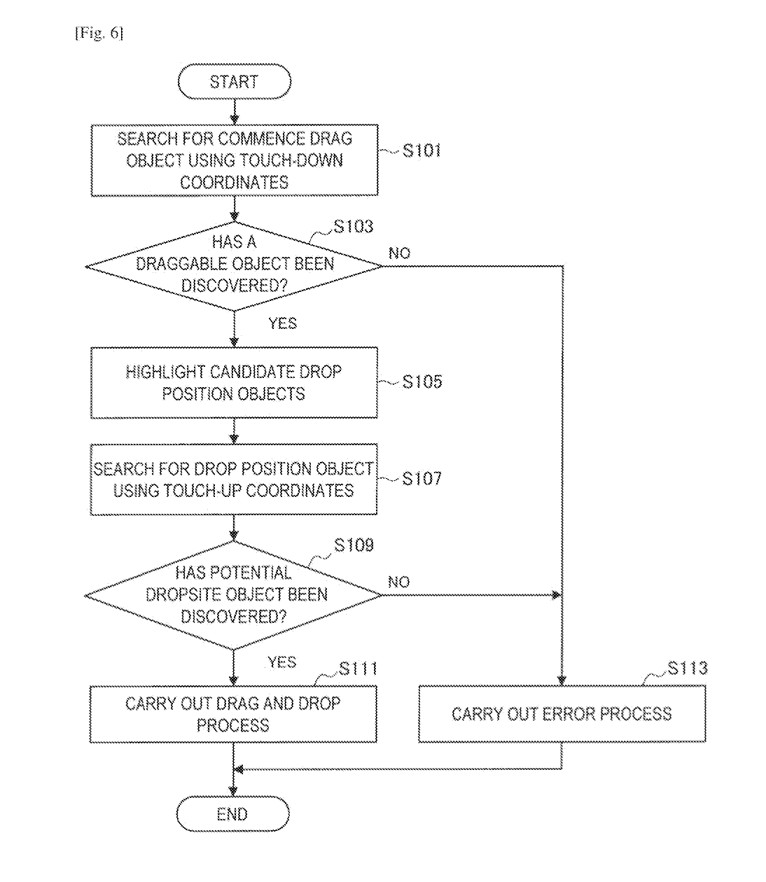

Next, an example of processing according to the first embodiment of the present disclosure will be described with reference to FIGS. 4 to 6. FIG. 4 is a diagram illustrating an example of a display screen according to the first embodiment. FIG. 5 is a diagram showing an example of object data according to the first embodiment. FIG. 6 is a flowchart showing an example of processing according to the first embodiment.

(Example of Display Screen)

As illustrated in FIG. 4, a display screen 331 to be displayed on the display unit 330 of the terminal apparatus 300 according to the first embodiment may include sign objects 501a to 501c and person objects 503a to 503e. Such objects are all recognized as objects included in the picked-up images by the server apparatus 100. Also, the displaying of such objects may be achieved by drawing the image data included in the picked-up image in its picked-up state or graphics corresponding to the respective objects may be drawn in accordance with the positions and postures of the respective objects. Note that the person object 503b may be the user U himself/herself who holds the terminal apparatus 300.

When such a display screen 331 is displayed, it is possible, for example, for the user U to carry out an operation that drags the sign object 501a (one example of the “first object”) and drops the sign object 501a on the person object 503b (one example of the “second object”) using a touch panel included in the operation unit 310 of the terminal apparatus 300. This type of operation has also been referred to as “an operation that indicates a first object and a second object” in the present specification. Such operations are not limited to drag and drop operations and as examples may be an operation that successively selects the sign object 501a and the person object 503b by touching or tapping, or may be an operation that flicks the sign object 501a in the direction of the person object 503b.

As described above, if an operation that indicates the sign object 501a and the person object 503b has been acquired, the associating unit 140 of the server apparatus 100 that acquires information on such operation via the operation information acquiring unit 130 may associate the information respectively corresponding to the objects. As one example, in the example in FIG. 4, the sign object 501a is an advertisement for the music software “XX the BEST” and the person object 503b is the user U himself/herself. For this reason, the associating unit 140 may transmit a file for a listening sample of the music software “XX the BEST” to the user U.

(Example of Information Corresponding to an Object)

In FIG. 5, the object data 151 is illustrated as an example of “information corresponding to an object”. In the illustrated example, data d_501a to d_501c corresponding to the sign objects 501a to 501c and data d_503a to d_503e corresponding to the person objects 503a to 503e are included in the object data 151. Note that for simplicity, although only data corresponding to the objects recognized in the example in FIG. 4 is illustrated in FIG. 5, in reality the object data 151 may also include data corresponding to objects that have not been recognized.

In the illustrated example, the object data 151 may include the items “ID”, “Object Name”, “Attribute”, “Content”, “Address”, “Operation A”, and “Operation B”.

“ID” may be a unique ID assigned to each object.

“Object Name” shows the name of each object. In the illustrated example, the names of the subjects of advertisements, such as “XX the BEST” and “Restaurant YY”, are set for the sign objects 501a to 501c and the names of people, such as “Carol” and “You”, are set for the person objects 503a to 503e. Such object names may be displayed at positions corresponding to the recognized objects, as illustrated in FIG. 4, for example.

“Attribute” may show an attribute of each object. In the illustrated example, the genres of the subjects of advertisements, such as “music software” and “eating and dining establishments” are set for the sign objects 501a to 501c and the relationship, such as “friend” or “self”, of such people to the user U are set for the person objects 503a to 503e.

“Content” may indicate content corresponding to the respective objects. Content corresponding to the respective subjects of the advertisements may be set for the sign objects 501. As one example, in the case of the sign object 501a that is an advertisement for music software, the file “listenMe.mp3” of a listening sample of music software is set as the “Content”; in the case of the sign object 501b that is an advertisement for an eating and dining establishment, the image file “coupon.jpg” of a coupon for an eating and dining establishment is set as the “Content”; and in the case of the sign object 501c that is an advertisement for a travel agent, the link file “zzTour.lnk” for the advertised web page is set as the “Content”.

“Content” may also be set for the person objects 503. In the illustrated example, profile information for the respective people, such as “carol.vcf”, is set as the “Content” for the person objects 503a to 503e.

“Address” may be set for the person objects 503. In the illustrated example, e-mail addresses of the respective people are set as the “Address” for the person objects 503a to 503e.

“Operation A” may be information showing an operation in a case where the respective objects are selected as a “commence drag” object (that is, the “first object”). In the illustrated example, “transmit ‘Content’ to drop destination” is set as “Operation A” for the sign objects 501 and the person objects 503a to 503d. Note that “Operation A” is not set for the person object 503e (“Roger”). In this way, depending on the type of object or the relationship (such as the existence or lack of permission) between the actual entity that corresponds to an object and the user U, there can be cases where “Operation A” is not set.

Meanwhile, “Operation B” may be information showing an operation in a case where the respective objects are selected as a “drop position” object (that is, the “second object”). In the illustrated example, “receive transmission from drag source at ‘Address’)” is set for the person objects 503a to 503d. Note that “Operation B” is not set for the sign objects 501 and the person object 503e (“Roger”). In this way, depending on the type of object or the relationship (such as the existence or lack of permission) between the actual entity that corresponds to an object and the user U, there are cases where “Operation B” is not set.

In the first embodiment, according to the setting of “Operation A” and “Operation B” in the object data 151 such as that described above, the associating unit 140 may associate information respectively corresponding to the first and second objects indicated by an operation by the user U.

For example, assume that the person object 503d (“John”) has been selected as the first object and that the person object 503a (“Carol”) has been selected as the second object. In this case, the associating unit 140 may refer to “Operation A” of data d_503d and “Operation B” of data d_503a and associate the information corresponding to the person object 503d and the information corresponding to the person object 503a by transmitting the “Content” (i.e., profile information) corresponding to the person object 503d to the “Address” corresponding to the person object 503a.

In this example, as a result, the profile information “john.vcf” of John (the person object 503d) may be transmitted to an address “carol@add.ress” of Carol (person object 503a). Naturally, in this case, the associating unit 140 may carry out supplementary processing, such as inquiring to the person (John) corresponding to the person object 503d as to whether the transmission of profile information is permitted.

The object data 151 such as that described above may be stored for example in the object database 150 of the server apparatus 100. The object data 151 may associate model data for recognizing objects and data of graphics to be displayed when an object is recognized. The object data 151 may be individually generated for each user U, for example. The object data 151 may be shared by a plurality of users U, and for personal data or the like, access permission may be set for each user U.

(Example of Processing Flow)

FIG. 6 illustrates the processing flow of the associating unit 140 of the server apparatus 100 for a case where an operation by the user U has been carried out as illustrated in FIG. 4. Note that as described previously, in this example, the terminal apparatus 300 may include a touch panel as the operation unit 310 and an operation by the user U that selects the first and second object may be a drag and drop operation using the touch panel.

First, the associating unit 140 may search for the commence drag object using “touch-down” coordinates (i.e., coordinates of the position where contact by the user started) included in the information provided from the operation information acquiring unit 130 (step S101). At this time, the associating unit 140 may refer to object information (including information on the positions of the objects) recognized by the object recognition unit 120 and the object data 151 stored in the object database 150.

Next, the associating unit 140 may determine whether a draggable object (that is, an object capable of becoming the first object) has been discovered (step S103). Here, the expression “draggable object” may refer to an object such that when the object is identified as the first object and another object is identified as the second object, the associating of some information between such objects is possible. In the example illustrated in FIGS. 4 and 5, objects for which “Operation A” has been set in the object data 151, that is, the sign objects 501a to 501c and the person objects 503a to 503d, may correspond to “draggable objects”.

In step S103, if a draggable object has been discovered, the associating unit 140 may transmit information (candidate object information) on candidates for the drop position object to the display control unit 320 of the terminal apparatus 300 to have candidate drop position objects highlighted in the display screen 331 displayed on the display unit 330 (step S105). By using a highlighted display, objects that are candidates for the drop position object can be easily recognized by the user. As one example, objects that are candidate drop position objects may be objects for which “Operation B” is set in the object data 151. Note that examples of the display at this time are described later.

Next, the associating unit 140 may search for the drop position object using “touch-up” coordinates (coordinates of a position where contact by the user is removed) provided from the operation information acquiring unit 130 (step S107). At this time, the associating unit 140 may refer again to information on the objects recognized by the object recognition unit 120 (including information on the positions of objects) and the object data 151 stored in the object database 150.

Next, the associating unit 140 may determine whether an object that is a potential dropsite (that is, an object that can be the second object) has been discovered (step S109). Here, the expression “potential dropsite” refers to an object such that when another object has been identified as the first object and the present object has been identified as the second object, it is possible to associate some information between the objects. In the example illustrated in FIGS. 4 and 5, objects for which “Operation B” has been set in the object data 151, that is, the person objects 503a to 503d, correspond to objects that are potential dropsites.

In step S109, if a droppable object has been discovered, the associating unit 140 may execute a drag and drop process (step S111). The drag and drop process may be a process that associates information corresponding the two objects indicated as the “commence drag object” and the “drop position object”. As described previously, the associating unit 140 may execute this process according to “Operation A” and “Operation B” in the object data 151.

Meanwhile if a draggable object has not been discovered in step S103 or if a potential dropsite object has not been discovered in step S109, the associating unit 140 may carry out an error process (step S113). As one example, the error process may be a process that transmits information relating to the error process to the display control unit 320 and has an error message or the like displayed on the display unit 330. Also, the error process may simply ignore the series of processing for a drag and drop operation. In addition, the associating unit 140 may carry out a search for a commence drag object or a drop position object once again.

### 1-4. Example Display of Candidate Objects

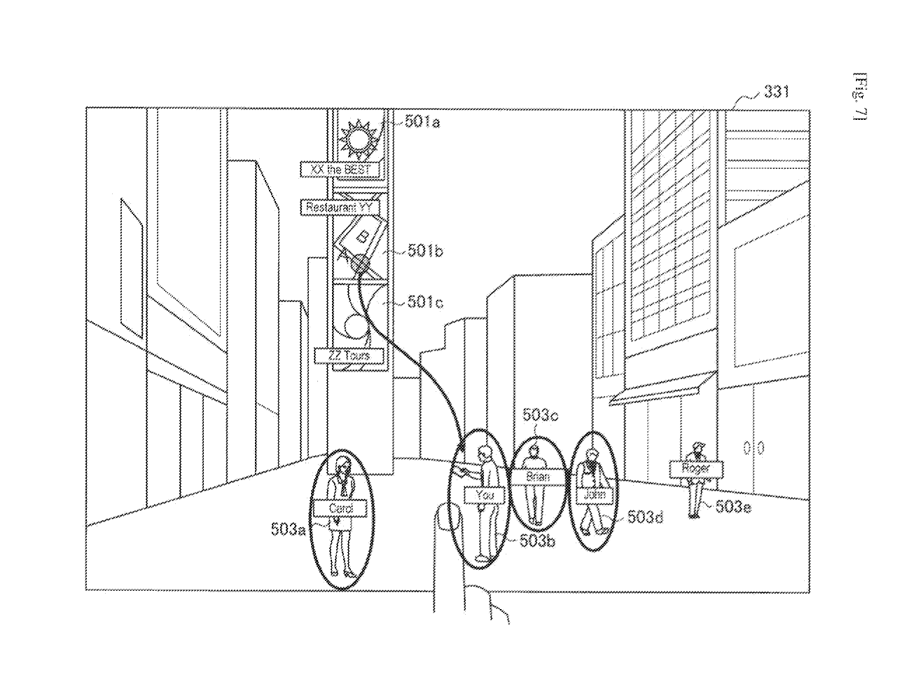

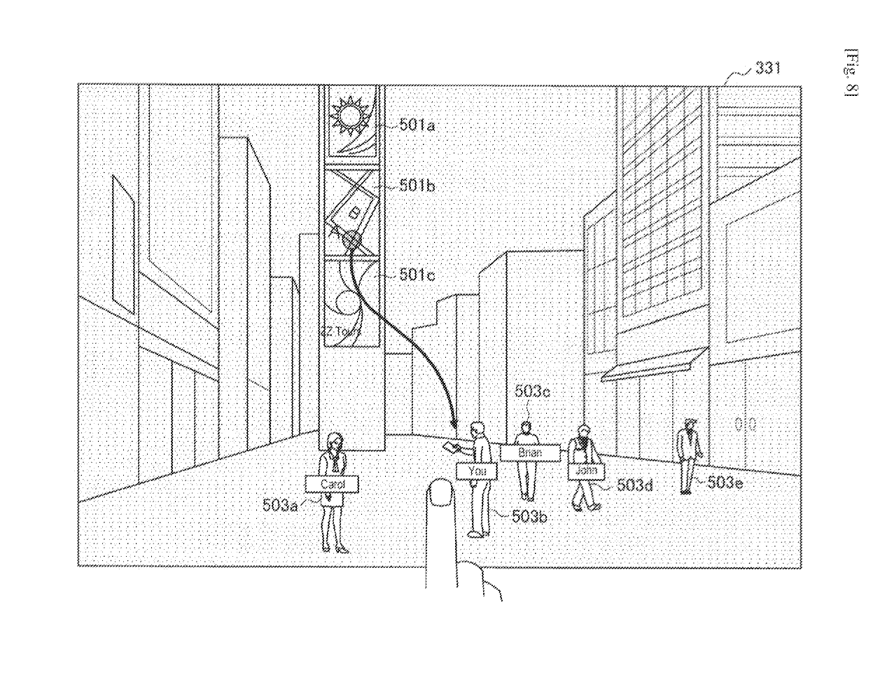

Next, an example of the displaying of candidates for the drop position object according to the first embodiment of the present disclosure will be described with reference to FIGS. 7 and 8. FIG. 7 is a diagram illustrating a first example of the displaying of candidate objects according to the first embodiment. FIG. 8 is a diagram illustrating a second example of the displaying of candidate objects according to the first embodiment.

As described previously, in the first embodiment, if a first object has been indicated by a drag operation, the associating unit 140 of the server apparatus 100 may transmit information (candidate object information) on drop destination candidate objects to the display control unit 320 of the terminal apparatus 300 to enable the user to recognize candidates for the drop position object on the display of the display unit 330. Two examples of such a display are described below.

In the first example illustrated in FIG. 7, the display control unit 320 may highlight the display of the person objects 503a to 503d that are candidates for the drop position object in the display screen 331 by surrounding the objects with frames, for example. From this display, the user U who is carrying out a drag and drop operation on the display screen 331 can easily grasp which objects are potential drop positions.

In the second example illustrated in FIG. 8, the display control unit 320 may suppress the displaying of objects aside from the person objects 503a to 503d that are candidates for the drop position object on the display screen 331 by graying out such objects and/or by hiding their names. From this display also, the user U who is carrying out a drag and drop operation on the display screen 331 can easily grasp which objects are potential drop positions.

According to the first embodiment of the present disclosure described above, by carrying out an operation that indicates objects included in a picked-up image for example, it is possible to easily carry out an operation that associates information corresponding to the respective objects. Also, with a configuration where a first object (for example, a commence drag object) has been indicated, second objects corresponding to such first object (for example, candidates for the drop position object) may be highlighted on the display, it is possible for the user to easily grasp what processing can be executed and the subjects of such processing.

### 2. Second Embodiment

### 2-1. Overview

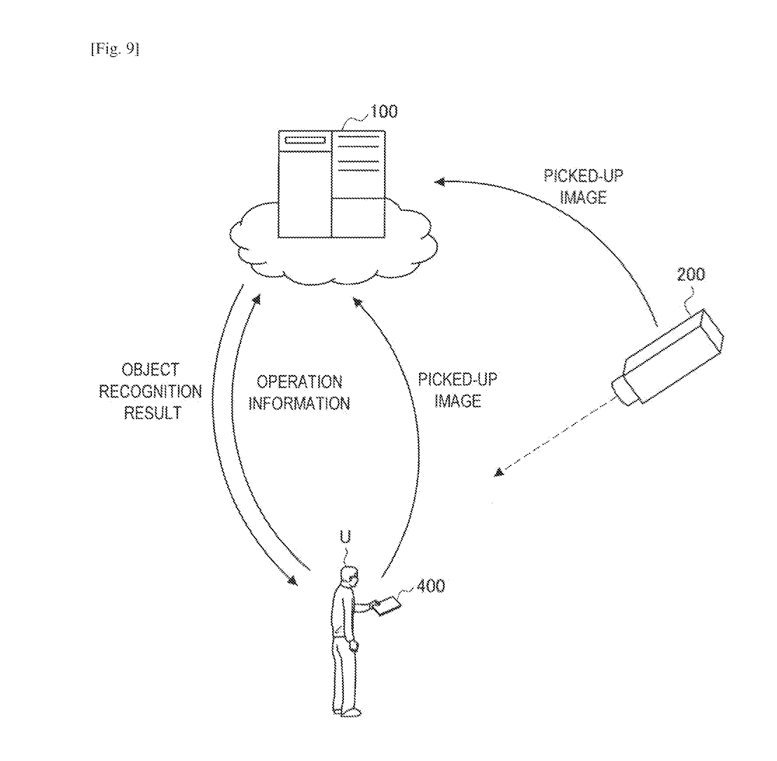

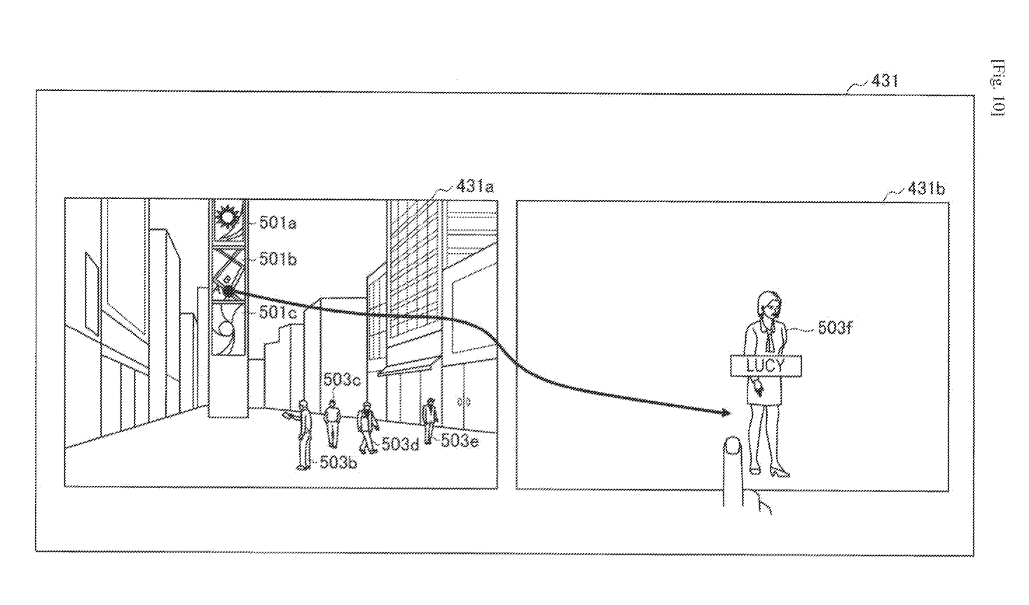

Next, an overview of the second embodiment of the present disclosure will be described with reference to FIGS. 9 and 10. FIG. 9 is a diagram illustrating an overview of the second embodiment. FIG. 10 is a diagram illustrating an example of a display screen for the example in FIG. 9.

As illustrated in FIG. 9, the second embodiment relates to the server apparatus 100 (one example of an “information processing apparatus”), the overhead camera 200, and a terminal apparatus 400. The server apparatus 100 and the overhead camera 200 may have the same configurations as in the first embodiment described above. The terminal apparatus 400 may have substantially the same configuration as the terminal apparatus 300 in the first embodiment but differ in that the terminal apparatus 400 itself may acquire picked-up images produced by an image pickup unit and transmit the picked-up images to the server apparatus 100.

As illustrated in FIG. 10, a display screen 431 displayed on the display unit 330 of the terminal apparatus 400 according to the second embodiment may include two subscreens 431a, 431b. In the illustrated example, the subscreen 431a may correspond to a first picked-up image acquired by the overhead camera 200. Meanwhile, the subscreen 431b may correspond to a second picked-up image acquired by the terminal apparatus 400.

In this case, the user U may be capable of carrying out a drag and drop operation that crosses between the two subscreens 431a, 431b on the display screen 431. In the second embodiment, the object recognition unit 120 of the server apparatus 100 may carry out an object recognition process for both the first and second picked-up images described above. For the objects that are recognized as a result of such process, the user U is capable of carrying out an operation that indicates such objects as the first and second objects regardless of the image in which such objects are included.

For example, as illustrated in the drawings, the user U may carry out an operation that drags the sign object 501a displayed in the subscreen 431a and then drops the sign object 501a on a person object 503f displayed in the subscreen 431b. In this case, if “Operation A” is set for the sign object 501a and “Operation B” is set for the person object 503f (“Lucy”) in the object data 151, the associating unit 140 may carry out a process that associates the information respectively corresponding to the objects. As one example, the associating unit 140 may transmit a listening sample for music content that is advertised by the sign object 501a to Lucy's mail address.

### 2-2. Apparatus Configurations

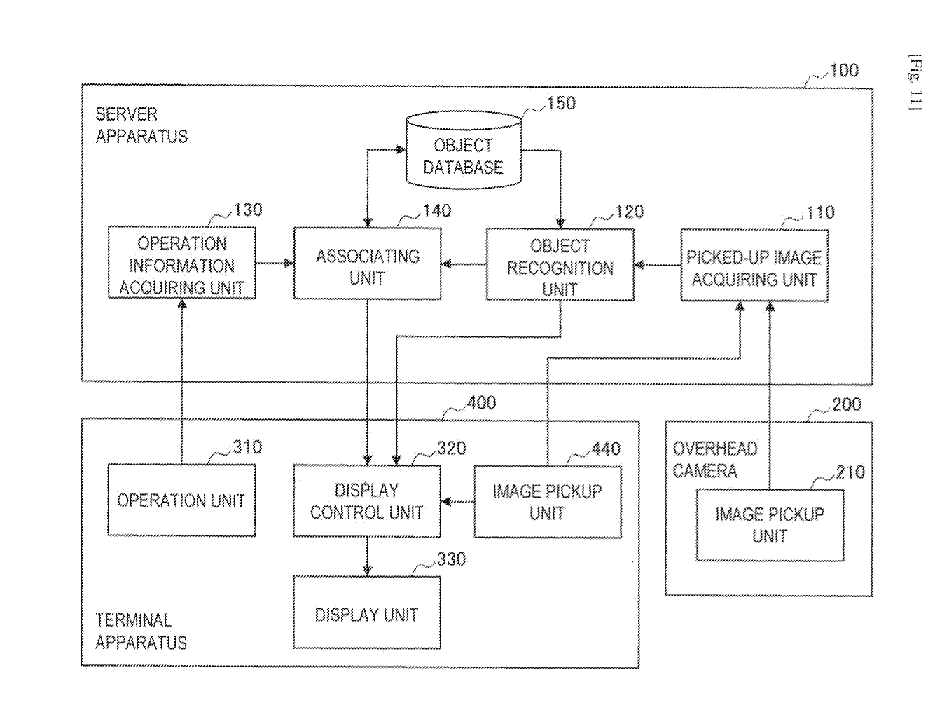

Next, the apparatus configurations of the second embodiment of the present disclosure will be described with reference to FIG. 11. FIG. 11 is a schematic block diagram illustrating the functional configuration of a system according to the present embodiment.

As described previously, in the second embodiment, the configurations of the server apparatus 100 and the overhead camera 200 may be the same as in the first embodiment described above and the terminal apparatus 400 may differ from the terminal apparatus 300 in the first embodiment by transmitting picked-up images to the server apparatus 100. For at least this reason, the terminal apparatus 400) may include an image pickup unit 440 in addition to the same component elements as the terminal apparatus 300 described above.

The image pickup unit 440 may be realized by an image pickup device incorporated in or externally connected to the terminal apparatus 400, for example, and may generate picked-up images of a real space. The image pickup unit 440 may pick up video images or may pick up still images. The image pickup unit 440 may provide image data on the generated picked-up images to the display control unit 320 and transmit such image data to the server apparatus 100.

The picked-up image acquiring unit 110 of the server apparatus 100 may acquire the picked-up images transmitted from the terminal apparatus 400 in addition to the picked-up images transmitted from the overhead camera 200. Aside from having two picked-up images subjected to processing, the processing by components from the object recognition unit 120 onwards may be similar as compared to the first embodiment described above.

Aside from the possibility of the indicated objects being present on different (i.e., a plurality of) picked-up images, processing and highlighted display by the second embodiment may be similarly achieved as to the examples given in the first embodiment described above, and for this reason further description is omitted.

According to the second embodiment of the present disclosure described above, even when a plurality of picked-up images are acquired, by carrying out an operation that indicates objects included in such picked-up images, it is possible to easily carry out an operation that associates information corresponding to the respective objects.

### 3. Other Embodiments

Note that embodiments of the present disclosure are not limited to those described above and can be subjected to various modifications as shown in at least the examples described below.

For example, “the process that associates the information respectively corresponding to the first and second objects” in embodiments described above can be various other processes.

The process may be a process that swaps the display positions of the first and second objects. By doing so, as one example the user is capable of adjusting the positions of objects so that objects, out of the sign objects, that are more interesting to the user may be displayed at positions that are easier to see.

The process may be a process that transmits information relating to the first object to the second object (or conversely a process that transmits information relating to the second object to the first object). Aside from the images, links, music, profiles, and the like described in the above embodiments, the transmitted information may be any type of information.

The process may also be a process that generates a connection between people indicated as the first and second objects. As one example, a communication channel, such as a chat room, on a network in which the people corresponding to the first and second objects (and possibly also the user himself/herself) participate may be generated by the process. Alternatively, the process may transmit a friend request for an SNS (Social Network Service) from the person indicated as the first object to the person indicated as the second object.

Although objects recognized from one of the images are indicated as the first and second objects in embodiments described above, one or both of the first and second objects may be an object that is not an object recognized from an image, that is, an icon. As one example, an icon representing the user U himself/herself may be displayed on the display screen together with a picked-up image and the recognized objects, and a process that indicates an arbitrary object and the icon so as to have information relating to the indicated object transmitted to the user may be carried out.

Also, although picked-up images may be acquired from an overhead camera in embodiments described above, embodiments of the present disclosure are not limited to such. As described earlier, picked-up images may also be acquired by a terminal apparatus. It is also possible to recognize objects and have objects indicated by the user in a picked-up image acquired by a terminal apparatus without using images picked-up by an overhead camera.

Although embodiments of the present disclosure that mainly relate to an information processing apparatus have been described above, as examples embodiments of the present disclosure may be realized by a method executed by an information processing apparatus, a program for causing an information processing apparatus to function, and a recording medium on which such program is recorded.

Also, although examples where a server apparatus functions as an information processing apparatus have been described above, as examples it is possible for a terminal apparatus or an overhead camera to function as an information processing apparatus.

### 4. Supplement

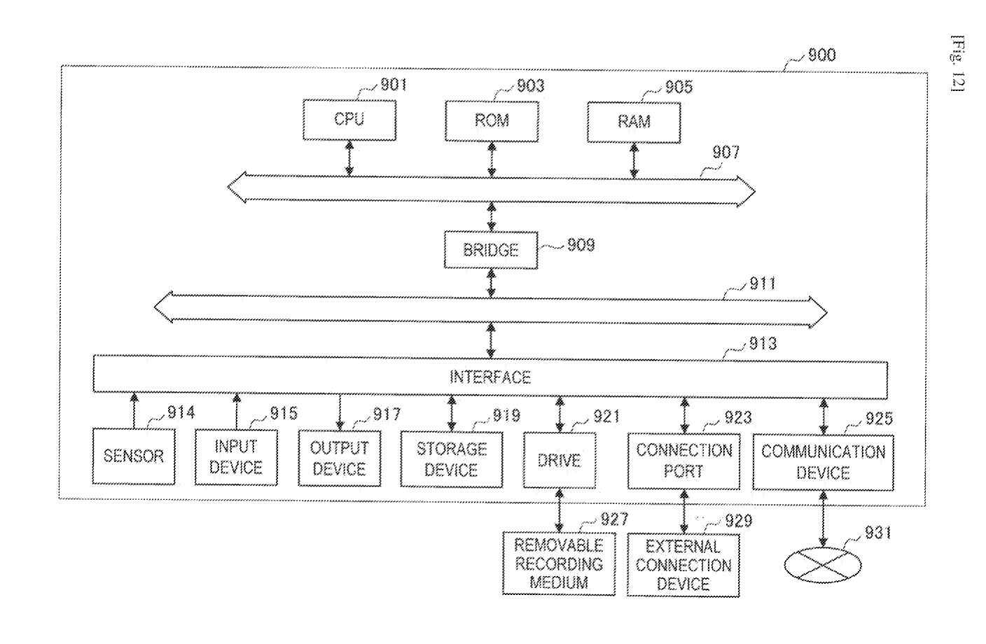

Finally, with reference to FIG. 12, description will be made of a hardware configuration of an information processing apparatus 900 capable of realizing the server apparatus 100, the overhead camera 200, and terminal apparatuses 300 and 400 according to embodiments of the present disclosure. FIG. 12 is a block diagram illustrating a hardware configuration of the information processing apparatus.

The information processing device 900 may include a CPU (Central Processing Unit) 901, ROM (Read Only Memory) 903, and RAM (Random Access Memory) 905. Further, the information processing device 900 may include a host bus 907, a bridge 909, an external bus 911, an interface 913, an input device 915, an output device 917, a storage device 919, a drive 921, a connection port 923, and a communication device 925. The information processing device 900 may include a processing circuit such as a DSP (Digital Signal Processor) in addition to or instead of the CPU 901.

The CPU 901 may function as an arithmetic processing unit and a control unit, and may control the entire operation within the information processing device 900 or a part thereof in accordance with various programs recorded on the ROM 903, the RAM 905, the storage 919, and/or the removable recording medium 927. The ROM 903 may store programs, operation parameters, and the like used by the CPU 901. The RAM 905 may temporarily store programs used in the execution of the CPU 901, parameters that change as appropriate during the execution, and the like. The CPU 901, the ROM 903, and the RAM 905 may be mutually coupled by a host bus 907 constructed from an internal bus such as a CPU bus. Further, the host bus 907 may be coupled to the external bus 911 such as a PCI (Peripheral Component Interconnect/Interface) via the bridge 909.

The input device 915 may be a device used by a user such as, for example, a mouse, a keyboard, a touch panel, a button, a switch, or a lever. The input device 915 may be, for example, a remote control device that uses infrared rays or other radio waves, or an external connection device 929 such as a portable phone corresponding to the operation of the information processing device 900. The input device 915 may include an input control circuit that generates an input signal based on information input by a user and output the input signal to the CPU 901. The user can, by operating the input device 915, input various data to the information processing device 900 or instruct the information processing device 900 to perform a processing operation.

The output device 917 may include a device that can visually or audibly inform a user of the acquired information. The output device 917 can be, for example, a display device such as an LCD (liquid crystal display), a PDP (Plasma Display Panel,) an organic EL (Electro-Luminescence) display; an audio output device such as a speaker or headphones; or a printer device. The output device 917 may output the result obtained through the processing of the information processing device 900 as text or video such as an image or as sound such as voice or audio.

The storage device 919 may be a device for storing data, constructed as an example of a storage unit of the information processing device 900. The storage device 919 may include, for example, a magnetic storage device such as a HDD (Hard Disk Drive), a semiconductor storage device, an optical storage device, or a magneto-optical storage device. This storage device 929 may include, for example, programs or various data executed by the CPU 901 or various data acquired from the outside.

The drive 921 may be a reader/writer for a removable recording medium 927 such as a magnetic disk, an optical disc, a magneto-optical disk, or semiconductor memory, and may be incorporated in or externally attached to the information processing device 900. The drive 921 may read information recorded on a removable recording medium 927 that is mounted, and output the information to the RAM 905. The drive 921 may also write information to the removable recording medium 927 that is mounted.

The connection port 923 may be a port for directly connecting a device to the information processing device 900. The connection port 923 can be, for example, a USB (Universal Serial Bus) port, an IEEE 1394 port, or a SCSI (Small Computer System Interface) port. In addition, the connection port 923 may be an RS-232C port, an optical audio terminal, or an HDMI (High-Definition Multimedia Interface) port. When the external connection device 929 is coupled to the connection port 923, the information processing device 900 and the external connection device 929 can exchange various data.

The communication device 925 may be, for example, a communication interface including a communication device or the like for connection to a communications network 931. The communication device 925 can be, for example, a wired or wireless LAN (Local Area Network) or a communication card for Bluetooth (registered trademark) or WUSB (Wireless USB). Alternatively, the communication device 925 may be a router for optical communication, a router for ADSL (Asymmetric Digital Subscriber Line), or a modem for various communication. The communication device 925 may transmit or receive signals or the like via the Internet or to/from other communication devices, for example, using a predetermined protocol such as TCP/IP. In addition, the communications network 931 coupled to the communication device 925 may be a network coupled by wire or wirelessly, and may be, for example, the Internet, a home LAN, infrared communication, radio wave communication, or satellite communication.

The image pickup device may be is, for example, an apparatus which captures a real world and may generate a captured image by using an image sensor such as a CCD (Charge Coupled Device) or CMOS (Complementary Metal Oxide Semiconductor) and various components such as lens for picking up a subject image to the image sensor. The image device 933 may be configured to pick up still images or moving images.

The sensor 935 may be various types of sensors such as an acceleration sensor, a gyro sensor, a geomagnetic sensor, an optical sensor, and an acoustic sensor. The sensor 935 may acquire information related to the state of an information processing apparatus 900 such as the shape of housing of the information processing apparatus 900 and information related to a surrounding environment of the information processing apparatus 900 such as brightness or noise in surroundings of the information processing apparatus 900. Moreover, the sensor 935 may include a GPS (Global Positioning System) sensor which receives a GPS signal and measures latitude, longitude and altitude of the apparatus.

An example of the hardware configuration of the information processing apparatus 900 has been described. The respective components described above may be configured using general purpose elements, and may be configured by hardware specialized to the function of the respective components. Such configurations can be appropriately changed according to the technical level at the time of implementing the embodiments of the present disclosure.

Although embodiments of the present disclosure are described in detail above with reference to the appended drawings, the disclosure is not limited thereto. It should be understood by those skilled in the art that various modifications, combinations, subcombinations and alterations may occur depending on design requirements and other factors insofar as they are within the scope of the appended claims or the equivalents thereof.

Additionally, the present technology may also be configured as below.

(1) An information processing apparatus including:

an image acquiring unit configured to acquire at least one captured image; and

an associating unit configured to associate a first information corresponding to a first object and a second information corresponding to a second object,

wherein the acquired at least one captured image comprises at least one selectable object depicted therewithin, and at least one of the first object and the second object corresponds to a respective one or ones of the at least one selectable object.

(2) The information processing apparatus of (1), wherein the first information corresponding to the first object and the second information corresponding to the second object are associated by transmitting a content associated with the first information to a location specified by the second information.

(3) The information processing apparatus of (1), further including:

an operation information acquiring unit configured to acquire information on an operation command, wherein the acquired information identifies the first object and the second object that have been intended for association by the association unit.

(4) The information processing apparatus of (3), wherein the operation command includes a drag-and-drop operation.

(5) The information processing apparatus of (4), wherein the first object is identified as that which has been dragged and dropped onto the second object, and the second object is identified as that upon which the first object has been dropped, during an execution of the operation command.

(6) The information processing apparatus of (1), further including:

an object recognition unit configured to recognize objects included in the at least one captured image, wherein the first object and the second object are selected from the recognized objects.

(7) The information processing apparatus of (1), wherein at least one of the first object and the second object is an icon representing a corresponding element depicted within the at least one captured image.

(8) The information processing apparatus of (1), wherein the first object and the second object are selected by first selecting the first object, and then selecting the second object from at least one indicated candidate.

(9) The information processing apparatus of (8), wherein the at least one indicated candidate is presented as a highlighted portion of the at least one captured image so as to indicate availability for selection.

(10) The information processing apparatus of (8), wherein the at least one indicated candidate is indicated as being available for selection by suppressing a displaying of all other objects in the at least one captured image.

(11) The information processing apparatus of (1), wherein the at least one captured image comprises an overhead viewpoint image depicting an overhead view of a region.

(12) The information processing apparatus of (11), wherein the overhead viewpoint image includes a user of the information processing apparatus as being an object that is depicted within the overhead viewpoint image.

(13) The information processing apparatus of (1), wherein the image acquiring unit is configured to acquire a first captured image and a second captured image.

(14) The information processing apparatus of (13), wherein one of the first object and the second object is selected from the first captured image, and the other one of the first object and the second object is selected from the second captured image.

(15) The information processing apparatus of (14), wherein the first captured image and the second captured image have been obtained by different imaging devices.

(16) The information processing apparatus of (1), wherein the first object and the second object are both selected from a same image of the at least one captured image.

(17) The information processing apparatus of (1), wherein the first object and the second object are depictions of real-world objects shown in the at least one captured image.

(18) An information processing method including:

acquiring at least one captured image;

identifying at least one of a first object and a second object as being found within the at least one captured image; and

associating a first information corresponding to the first object and a second information corresponding to the second object.

(19) The information processing method of (18), wherein the acquired at least one captured image includes at least one selectable object depicted therewithin, and at least one of the first object and the second object corresponds to a respective one or ones of the at least one selectable object.

(20) The information processing method of (18), wherein the associating the first information and the second information includes transmitting content associated with the first information to a location specified by the second information.

(21) The information processing method of (18), wherein the first object and the second object are identified by receipt of an operation command.

(22) The information processing method of (21), wherein the operation command includes a drag-and-drop operation.

(23) The information processing method of (22), wherein during an execution of the operation command, the first object is identified as that which has been dragged and dropped onto the second object and the second object is identified as that upon which the first object has been dropped.

(24) The information processing method of (18), further including:

recognizing objects included in the acquired at least one captured image, wherein the identified at least one of the first object and the second object are selected from the recognized objects.

(25) The information processing method of (18), wherein at least one of the first object and the second object having been identified is an icon representing a corresponding element depicted within the at least one captured image.

(26) The information processing method of (18), wherein the first object is identified prior to identifying the second object, and the second object is identified by selecting from at least one candidate indicated as being available based on the identified first object.

(27) The information processing method of claim 26, further including:

presenting the at least one indicated candidate as a highlighted portion of the at least one captured image so as to indicate availability of the at least one indicated candidate for selection.

(28) The information processing method of (26), further including:

suppressing a display of all objects in the at least one captured image except for the at least one indicated candidate so as to indicate availability of the at least one indicated candidate for selection.

(29) The information processing method of (18), wherein the at least one captured image includes an overhead viewpoint image that depicts an overhead view of a region.

(30) The information processing method of (18), wherein the acquiring the at least one captured image includes acquiring a first captured image and acquiring a second captured image.

(31) The information processing method of (30), wherein one of the first object and the second object is identified from the first captured image, and the other one of the first object and the second object is identified from the second captured image. (32) The information processing method of (31), wherein the first captured image and the second captured image have been obtained by different imaging devices.

(33) The information processing method of (18), wherein the first object and the second object are both selected from a same captured image of the at least one captured image.

(34) The information processing method of (18), wherein the first object and the second object are depictions of real-world objects shown in the at least one captured image.

(35) A non-transitory computer-readable medium embodied with a program, which when executed by a computer, causes the computer to perform a method including:

acquiring at least one captured image;

identifying at least one of a first object and a second object as being found within the at least one captured image; and

associating a first information corresponding to the first object and a second information corresponding to the second object.

(36) The computer-readable medium of (35), wherein the acquired at least one captured image includes at least one selectable object depicted therewithin, and at least one of the first object and the second object corresponds to a respective one or ones of the at least one selectable object.

(37) An information processing apparatus including:

an operation information acquiring unit acquiring operation information showing an operation by a user who indicates a first object and a second object from objects that are recognized from a picked-up image; and

an associating unit associating first information corresponding to the first object and second information corresponding to the second object based on the operation information.

(38) The information processing apparatus according to (37),

wherein the associating unit is operable when the operation information showing an operation by the user indicating the first object has been acquired, to search the objects for candidate objects that are capable of becoming the second object and to output candidate object information showing the candidate objects.

(39) The information processing apparatus according to (38),

wherein the candidate object information is information for enabling the user to recognize the candidate objects on a display unit displaying the picked-up image and images corresponding to the objects.

(40) The information processing apparatus according to (39),

wherein the candidate object information is information for highlighting images corresponding to the candidate objects on the display unit.

(41) The information processing apparatus according to (39),

wherein the candidate object information is information for suppressing display of images corresponding to objects aside from the candidate objects on the display unit.

(42) The information processing apparatus according to any one of (37) to (41),

wherein the picked-up image includes an image picked up from a viewpoint that overlooks a region including the user.

(43) The information processing apparatus according to (42),

wherein one of the first object and the second object is an object showing the user.

(44) The information processing apparatus according to any one of (37) to (43),

wherein the picked-up image includes a first image and a second image picked up from different viewpoints, and

one of the first object and the second object is an object recognized from the first image and another of the first object and the second object is an object recognized from the second image.

(45) The information processing apparatus according to any one of (37) to (44),

wherein the first information is content corresponding to the first object,

the second information is an address corresponding to the second object, and

the associating unit transmits the content to the address.

(46) The information processing apparatus according to (45),

wherein the first object is a first person,

the second object is a second person, and

the content is profile information of the first person.

(47) The information processing apparatus according to any one of (37) to (44),

wherein the first object is a first person,

the second object is a second person, and

the associating unit generates a communication channel between the first person and the second person.

(48) The information processing apparatus according to any one of (37) to (44),

wherein the associating unit interchanges a display position of an image corresponding to the first object and a display position of an image corresponding to the second object on a display unit displaying the picked-up image and images corresponding to the objects.

(49) The information processing apparatus according to any one of (37) to (48),

wherein the operation by the user who indicates the first object and the second object is an operation that drags the first object and drops the first object on the second object.

(50) An information processing method including:

acquiring operation information showing an operation by a user who indicates a first object and a second object from objects that are recognized from a picked-up image; and

associating first information corresponding to the first object and second information corresponding to the second object based on the operation information.

(51) A program for causing a computer to realize:

a function acquiring operation information showing an operation by a user who indicates a first object and a second object from objects that are recognized from a picked-up image; and

a function associating first information corresponding to the first object and second information corresponding to the second object based on the operation information.

The present disclosure contains subject matter related to that disclosed in Japanese Priority Patent Application JP 2012-069714 filed in the Japan Patent Office on Feb. 10, 2012, the entire content of which is hereby incorporated by reference.

1. An information processing apparatus comprising:
an image acquiring unit configured to acquire at least one captured image; and
an associating unit configured to associate a first information corresponding to a first object and a second information corresponding to a second object,
wherein the acquired at least one captured image comprises at least one selectable object depicted therewithin, and at least one of the first object and the second object corresponds to a respective one or ones of the at least one selectable object.

2. The information processing apparatus of claim 1, wherein the first information corresponding to the first object and the second information corresponding to the second object are associated by transmitting a content associated with the first information to a location specified by the second information.

3. The information processing apparatus of claim 1, further comprising:
an operation information acquiring unit configured to acquire information on an operation command, wherein the acquired information identifies the first object and the second object that have been intended for association by the association unit.

4. The information processing apparatus of claim 3, wherein the operation command comprises a drag-and-drop operation.

5. The information processing apparatus of claim 4, wherein the first object is identified as that which has been dragged and dropped onto the second object, and the second object is identified as that upon which the first object has been dropped, during an execution of the operation command.

6. The information processing apparatus of claim 1, further comprising:
an object recognition unit configured to recognize objects included in the at least one captured image, wherein the first object and the second object are selected from the recognized objects.

7. The information processing apparatus of claim 1, wherein at least one of the first object and the second object is an icon representing a corresponding element depicted within the at least one captured image.

8. The information processing apparatus of claim 1, wherein the first object and the second object are selected by first selecting the first object, and then selecting the second object from at least one indicated candidate.

9. The information processing apparatus of claim 8, wherein the at least one indicated candidate is presented as a highlighted portion of the at least one captured image so as to indicate availability for selection.

10. The information processing apparatus of claim 8, wherein the at least one indicated candidate is indicated as being available for selection by suppressing a displaying of all other objects in the at least one captured image.

11. The information processing apparatus of claim 1, wherein the at least one captured image comprises an overhead viewpoint image depicting an overhead view of a region.

12. The information processing apparatus of claim 11, wherein the overhead viewpoint image includes a user of the information processing apparatus as being an object that is depicted within the overhead viewpoint image.

13. The information processing apparatus of claim 1, wherein the image acquiring unit is configured to acquire a first captured image and a second captured image.

14. The information processing apparatus of claim 13, wherein one of the first object and the second object is selected from the first captured image, and the other one of the first object and the second object is selected from the second captured image.

15. The information processing apparatus of claim 14, wherein the first captured image and the second captured image have been obtained by different imaging devices.

16. The information processing apparatus of claim 1, wherein the first object and the second object are both selected from a same image of the at least one captured image.

17. The information processing apparatus of claim 1, wherein the first object and the second object are depictions of real-world objects shown in the at least one captured image.

18. An information processing method comprising:
acquiring at least one captured image;
identifying at least one of a first object and a second object as being found within the at least one captured image; and
associating a first information corresponding to the first object and a second information corresponding to the second object.

19. A non-transitory computer-readable medium embodied with a program, which when executed by a computer, causes the computer to perform a method comprising:
acquiring at least one captured image;
identifying at least one of a first object and a second object as being found within the at least one captured image; and
associating a first information corresponding to the first object and a second information corresponding to the second object.
